(19) United States
(12) Patent Application Publication
(10) Pub. No.: US 2025/0051128 A1
(43) Pub. Date: Feb. 13, 2025

(54) CABLE/WIRE DISPENSER APPARATUS, AND A METHOD OF STORAGE AND ONSITE DISPENSING OF CABLE/WIRE

(71) Applicant: Jason McEwan, Pleasant Valley, NY (US)

(72) Inventor: Jason McEwan, Pleasant Valley, NY (US)

(21) Appl. No.: 18/231,781

(22) Filed: Aug. 8, 2023

(51) Int. Cl. B65H 49/32

(52) U.S. Cl. CPC B65H 49/324

(57) ABSTRACT

The present invention relates generally to a cable/wire dispenser apparatus, and a method of storage and onsite dispensing of cable/wire. More particularly, the invention encompasses an inventive cable/wire dispensing apparatus that is modular, portable, and easy to use. The inventive cable/wire dispenser apparatus can be easily removeably secured to the outside of a standard installation bucket without the need for any special tools or accommodations. The invention also provides a method of using the inventive cable/wire dispenser apparatus with existing vehicles that are used to install cables/wires in the industry. The cable/wire dispenser apparatus could be color coded so that multiple cable/wires could be secured to the dispenser apparatus during the installation process without the need for the installer to change dispenser trays or switch dispenser trays during cable/wire installation. The bucket mounting bracket can accommodate different types of mounting posts, and one or more cable/wire dispenser trays.

### FIELD OF THE INVENTION

The present invention relates generally to a cable/wire dispenser apparatus, and a method of storage and onsite dispensing of cable/wire. More particularly, the invention encompasses an inventive cable/wire dispensing apparatus that is modular, portable, and easy to use. The inventive cable/wire dispenser apparatus can be easily removeably secured to the outside of a standard installation bucket without the need for any special tools or accommodations. The invention also provides a method of using the inventive cable/wire dispenser apparatus with existing vehicles that are used to install cables/wires in the industry. The cable/wire dispenser apparatus could be color coded so that multiple cable/wires could be secured to the dispenser apparatus during the installation process without the need for the installer to change dispenser trays or switch dispenser trays during cable/wire installation. The bucket mounting bracket can accommodate different types of mounting posts, and one or more cable/wire dispenser trays.

### BACKGROUND INFORMATION

Cables and wires have been used in the industry for a variety of reasons, and there are several ways to install or lay the cables and wires. Cables and wires are typically wound on a spool, and then it is transported to the installation location. The installation location could be the side of a road, a highway, a parking lot, a warehouse, a large building, a house, to name a few. In most all cases the installation of the cables and wires is a labor-intensive operation, and in most cases requires one or more spool of cable or wire, depending on the installation location or needs.

Traditionally, the cable or wire is normally delivered in large industrial spools from the factory to a warehouse or to a jobsite and where an operator or installer would roughly calculate the amount of wire or cable, they could easily handle in an installation bucket of a bucket truck, as the installation bucket has to accommodate the cable/wire installer along with the cable/wire which are typically dropped onto the floor of the installation bucket during the cable/wire installation, and from which the cable/wire draws from during the cable/wire installation. It should be appreciated that the installation bucket has limited room to not only accommodate the cable/wire installer, but also the cable/wire material. Furthermore, it should be appreciated that these industrial spools containing the cable or wires are very big and cannot be lifted or moved by a person without the use of specialized industrial vehicles or tools. Thus, once the cable or wire installer has roughly determined the amount of cable or wire the installer needs, the installer would then have to pull the loose cable/wire from the industrial spool which has the cable/wire coiled or wound around it. The installer would then lay the loose cable/wire pulled from the industrial spool onto the ground, and then rewind the loose cable/wire onto a smaller spool or just collect the loose cable/wire and just drop it into the bucket, and then draw from this loose cable/wire the amount the installer needed from either the smaller spool or the loose cable or wire on the floor of the bucket. Thus, one can clearly see that this is a very labor-intensive job, and also very time consuming, especially, when the installer is high-up on a bucket truck, and constantly needs to come down to collect the cable or wire, or runs short of cable or wire during his rough estimation, and so the installer now needs to put a splice or make some other arrangements to continue to install the cable or wire which is usually up on a pole or substantially higher than the height of an average person, and that is why a bucket truck or an aerial vehicle is used for the installation of cable or wire.

Additionally, if an operator hand coils the cable/wire from the industrial spool then by peeling off one loop at a time then it will result in twists in the cable when it is deployed, making it much more difficult to manage the cable/wire slack and increasing the potential for damage to the jumper wire/cable, and this is one of the main reason that the operator lays the cable/wire from the industrial spool on the ground to straighten out the jumper wire/cable that is needed, and once the jumper wire/cable that is needed has been straighten out then the operator gathers the jumper wire/cable and places it into his installation bucket, and then moves the installation bucket close to the location where the cable/wire or cable/wire jumper needs to be installed.

This invention improves on the deficiencies of the prior art and provides an inventive cable or wire dispenser apparatus, and a method of storage and onsite dispensing of cable or a wire.

### PURPOSES AND SUMMARY OF THE INVENTION

The invention is a novel cable/wire dispenser apparatus, and a method of storage and onsite dispensing of cable/wire.

Therefore, one purpose of this invention is to provide a cable/wire dispenser apparatus, and a method of storage and onsite dispensing of cable/wire.

Another purpose of this invention is to provide a cable/wire dispenser apparatus that is color coded to assist an installer.

Yet another purpose of this invention is to provide a cable/wire dispenser apparatus that can be easily and securely secured to a bucket of an existing cable/wire installation bucket.

Still yet another purpose of this invention is to provide a cable/wire mounting bracket that can accommodate at least one cable/wire tray, for the installation of jumper cable/wire.

Therefore, in one aspect this invention comprises a cable/wire installation apparatus, comprising:
(a) a center shaft having a bucket extension at one end, and a spool extension at an opposite end, said bucket extension having a lip extension at a free end, and wherein said lip extension points towards earth, said spool extension has a post holder at a free end, and wherein said post holder has a central through hole;
(b) a post having a post stop, said post stop having an upper surface, and a lower surface, and wherein one end of said post stop is inserted into said central through hole, while said lower surface of said post stop rests on a surface of said post holder; and
(c) a cable/wire tray having a through hole is inserted onto said post, such that a base of said cable/wire tray rests on an upper surface of said post stop.

In another aspect this invention comprises a cable/wire installation apparatus, comprising:
(a) a center shaft having a bucket extension at one end, and a spool extension at an opposite end, said bucket extension having a lip extension at a free end, and wherein said lip extension points towards earth, said spool extension has a post holder at a free end, and wherein said post holder has a central through hole;
(b) a post having a post stop, said post stop having an upper surface, and a lower surface, and wherein one end of said post stop is inserted into said central through hole, while said lower surface of said post stop rests on a surface of said post holder;
(c) a cable/wire tray having a through hole is inserted onto said post, such that a base of said cable/wire tray rests on an upper surface of said post stop; and
(d) an installation bucket having a base, a sidewall having a bottom end and a top end, and where a portion of said bottom end is connected to said base, and at least one lip extension is connected along at least a portion of said top end, and wherein bucket extension rests on top of said at least one lip extension, such that said lip extension of said bucket extension is inside said installation bucket.

In yet another aspect this invention comprises a cable/wire installation apparatus, comprising:
(a) a center shaft having a bucket extension at one end, and a spool extension at an opposite end, said bucket extension having a lip extension at a free end, and wherein said lip extension points towards earth, said spool extension has a post holder at a free end, and wherein said post holder has a central through hole;
(b) a post having a post stop, said post stop having an upper surface, and a lower surface, and wherein one end of said post stop is inserted into said central through hole, while said lower surface of said post stop rests on a surface of said post holder;
(c) a cable/wire tray having a through hole is inserted onto said post, such that a base of said cable/wire tray rests on an upper surface of said post stop;
(d) an installation bucket having a base, a sidewall having a bottom end and a top end, and where a portion of said bottom end is connected to said base, and at least one lip extension is connected along at least a portion of said top end, and wherein bucket extension rests on top of said at least one lip extension, such that said lip extension of said bucket extension is inside said installation bucket; and
(e) an installation vehicle, said installation vehicle having a housing having at least one extension, wherein one end of said at least one extension is moveable secured to said housing, and an opposite end is secured to said installation bucket.

### BRIEF DESCRIPTION OF THE DRAWINGS

The invention may best be further understood by reference to the ensuing detailed description in conjunction with the drawings in which:

FIG. 1, illustrates a side view of an inventive cable/wire dispenser rack apparatus according to a first embodiment of this invention.

FIG. 2, illustrates a side view of an inventive cable/wire dispenser spool tray post apparatus according to a second embodiment of this invention.

FIG. 3, illustrates a perspective view of an inventive cable/wire dispenser spool tray apparatus according to a third embodiment of this invention.

FIG. 4, illustrates a perspective view of an inventive cable/wire dispenser spool tray cover apparatus according to a fourth embodiment of this invention.

FIG. 5, illustrates a side view of an inventive cable/wire dispenser rack apparatus, and having an inventive cable/wire dispenser spool tray post apparatus, according to a fifth embodiment of this invention.

FIG. 6, illustrates a perspective view of an inventive cable/wire dispenser spool tray apparatus having cable/wire according to a sixth embodiment of this invention.

FIG. 7, illustrates a side view of an inventive cable/wire dispenser rack apparatus having a cable/wire dispenser spool tray and spool tray cover secured to an installation bucket according to a seventh embodiment of this invention.

FIG. 8, illustrates a side view of an inventive cable/wire dispenser rack apparatus having a cable/wire dispenser spool tray and spool tray cover secured to an installation bucket on a bucket truck according to an eight embodiment of this invention.

### DETAILED DESCRIPTION

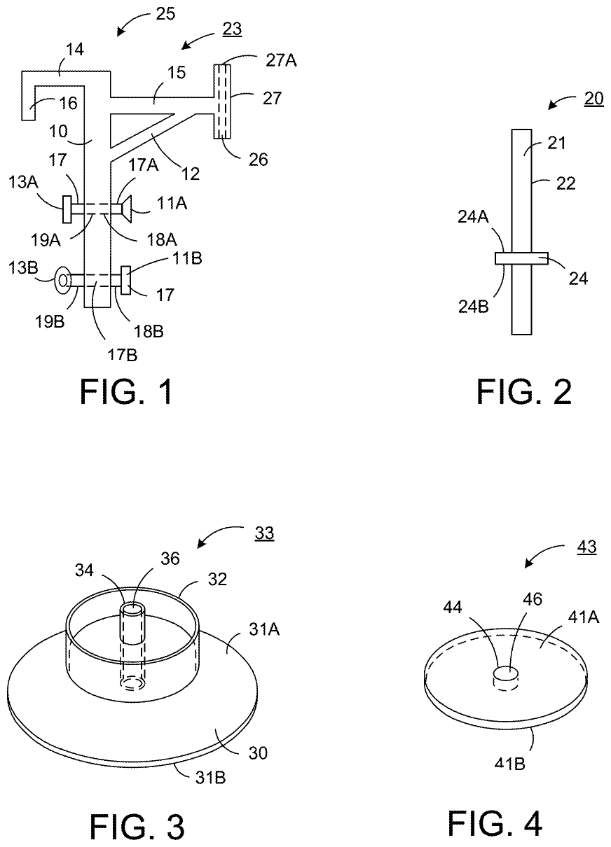

The inventive cable/wire dispenser apparatus, and a method of storage and onsite dispensing of cable/wire will now be discussed with reference to FIGS. 1 through 8. Although the scope of the present invention is much broader than any particular embodiment, a detailed description of the preferred embodiment follows together with drawings. These drawings are for illustration purposes only and are not drawn to scale. Like numbers represent like features and components in the drawings.

FIG. 1, illustrates a side view of an inventive cable/wire dispenser rack apparatus 23, according to a first embodiment of this invention. The inventive cable/wire dispenser rack apparatus 23, comprises of at least one bucket mounting bracket 25, having at least one center or central shaft 10, having at least one bucket extension 14, on one side and at least one spool tray brace arm or spool extension 15, on an opposite side. The at least one bucket extension 14, has at least one lip or extension 16, at an end away from the at least one center shaft 10. For some applications the at least one spool tray brace arm 15, could also have at least one brace or support arm 12, which physically and securely connects a side portion of the at least one center shaft 10, to the bottom or side of the at least one spool tray brace arm 15. The least one spool tray brace arm 15, has at least one post holder 27, secured to the end of the least one spool tray brace arm 15, but away from the at least one center shaft 10. For some applications the at least one post holder 27, could have at least one hole or opening 26, along the center or vertical axis. The inventive cable/wire dispenser rack apparatus 23, should also have at least one securing means 17, or at least one first securing means 17A. The at least one first securing means 17A, are preferably along the bottom half of the center shaft 10, and are along a horizontal axis. The at least one securing means 17A, comprises of a shaft 19A, having a knob 11A, at one end and a securing pad 13A, at an opposite end. The shaft 19A, is passed through an opening or hole 18A, in the central shaft 10, such that the knob 11A, is on the side of the post holder 27, and that the securing pad 13A, is on the side of the bucket extension 14, or lip 16. For some applications one could have at least one second securing means 17, such as, at least one second securing means 17B, and where the at least one second securing means 17B, could comprise of a shaft 19B, having a handle 11B, at one end and a securing bumper 13B, at an opposite end. The shaft 19B, is passed through an opening or hole 18B, in the central shaft 10, such that the handle 11B, is on the side of the post holder 27, and that the securing bumper 13B, is on the side of the bucket extension 14, or lip 16. For some applications the outer surface of the shaft 19A, 19B, could have screw threads so as to allow the shaft 19A, 19B, to move back and forth as a screw when the knob 11A, or the handle 11B, is rotated in a clockwise or counterclockwise direction.

FIG. 2, illustrates a side view of an inventive cable/wire dispenser spool tray post apparatus 20, according to a second embodiment of this invention. The inventive cable/wire dispenser spool tray post apparatus 20, comprises of a center shaft or mounting post 21, having an outside post surface 22, and at least one post stop 24. The at least one post stop 24, is preferably located towards the bottom half of the inventive cable/wire dispenser spool tray post apparatus 20, along the outer or peripheral surface 22, of the center shaft or mounting post 21. The at least one post stop 24, has a top or upper or first surface 24A, and a bottom or lower or second surface 24B. It should be appreciated that the center shaft or mounting post 21, is along a vertical axis, while the at least one post stop 24, is substantially along the horizontal axis.

FIG. 3, illustrates a perspective view of an inventive cable/wire dispenser spool tray apparatus 33, according to a third embodiment of this invention. The inventive cable/wire dispenser spool tray apparatus 33, comprises of at least one base 30, and having an upper or top or first surface 31A, and a lower or bottom or second surface 31B. The inventive cable/wire dispenser spool tray apparatus 33, has a central hole or opening 36. For some applications one could also have a tray pipe or cylinder 34, surrounding the central hole or opening 36. For some applications the tray pipe or cylinder 34, surrounding the central hole or opening 36, could be secured along a peripheral edge of the hole or opening 36. For some applications one could also have at least one first or inner spool side wall 32, secured to the upper or top or first surface 31A. It is preferred that the at least one inner spool side wall 32, is either of a circular or an oval shape.

FIG. 4, illustrates a perspective view of an inventive cable/wire dispenser spool tray cover apparatus 43, according to a fourth embodiment of this invention. The inventive cable/wire dispenser spool tray cover apparatus 43, has an upper or top or first surface 41A, and a lower or bottom or second surface 41B, and having a central hole or opening 46. For some applications one could also have a cover pipe or cylinder 44, surrounding the central hole or opening 46. For some applications the cover pipe or cylinder 44, surrounding the central hole or opening 46, could be secured along a peripheral edge of the hole or opening 46. It should be appreciated that that the cover pipe or cylinder 44, could be on the upper or top or first surface 41A, or on the lower or bottom or second surface 41B, or along both sides or surfaces 41A, 41B.

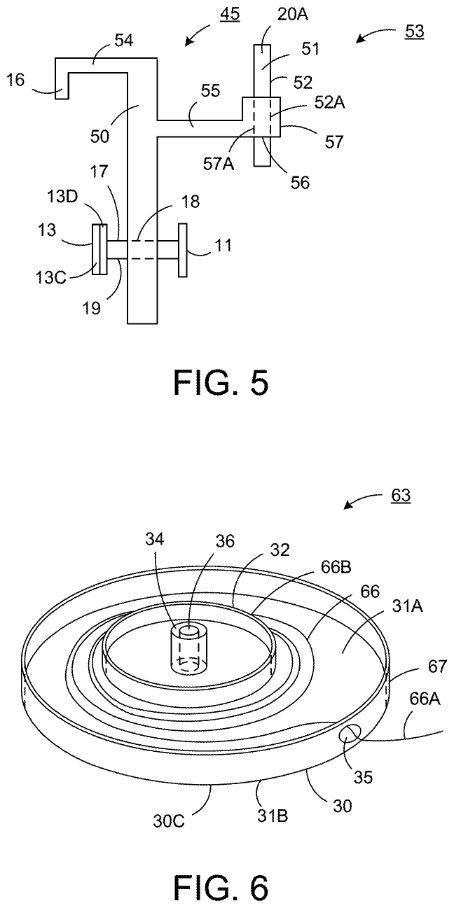

FIG. 5, illustrates a side view of an inventive cable/wire dispenser rack apparatus 53, and having an inventive cable/wire dispenser spool tray post apparatus 20A, according to a fifth embodiment of this invention. The inventive cable/wire dispenser rack apparatus 53, comprises of at least one bucket mounting bracket 45, having at least one center or central shaft 50, having at least one bucket extension 54, on one side and at least one spool tray brace arm or spool extension 55, on an opposite side. The at least one bucket extension 54, has at least one lip or extension 16, at an end away from the at least one center shaft 50. The least one spool tray brace arm 55, has at least one post holder 57, secured to the end of the least one spool tray brace arm 55, but away from the at least one center shaft 50. For some applications the at least one post holder 57, could have at least one hole or opening 56, along the center or vertical axis. The inventive cable/wire dispenser spool tray post apparatus 20A, comprises of a center shaft or mounting post 51, having an outside post surface 52. The outside post surface 52, has at least one securing means 52A, along at least a portion of the outside post surface 52, and where the at least one securing means 52A, could be selected from a group comprising a male thread 52A, a female thread 52A, a frictional clamping means 52A, a conical surface 52A, and combinations thereof, to name a few. Similarly, the at least one post holder 57, could have a surface 57A, having a complementary or opposite securing means to accommodate the at least one securing means 52A, so that surfaces 52A, and 57A, securely, engageably, and moveably mate with each other. It should be appreciated that both the center shaft or mounting post 51, and the spool post holder 57, are along a vertical axis when they mate with each other. The inventive cable/wire dispenser rack apparatus 53, should also have at least one securing means 17. The at least one securing means 17, is preferably along the bottom half of the center shaft 50, and is substantially along a horizontal axis. The at least one securing means 17, comprises of a shaft 19, having a handle 11, at one end and a securing pad or bumper 13, at an opposite end. The shaft 19, is passed through an opening or hole 18, in the central shaft 50, such that the handle 11, is on the side of the post holder 57, and that the securing pad or bumper 13, is on the side of the bucket extension 54, or lip 16. For some applications the outer surface of the shaft 19, could have screw threads so as to allow the shaft 19, to move back and forth as a screw when the handle 11, is rotated in a clockwise or counterclockwise direction. For some applications the securing pad or bumper 13, could comprise a plurality of pads 13C, 13D, etc., and where the material for a first pad or bumper 13C, could be different that the material for a second pad or bumper 13D, or the materials for the pads 13C, 13D, etc., could be the same.

FIG. 6, illustrates a perspective view of an inventive cable/wire dispenser spool tray apparatus 63, having cable/wire 66, according to a sixth embodiment of this invention. The inventive cable/wire dispenser spool tray apparatus 63, comprises of at least one base 30, and having an upper or top or first surface 31A, and a lower or bottom or second surface 31B. The inventive cable/wire dispenser spool tray apparatus 63, has a central hole or opening 36. For some applications one could also have a tray pipe or cylinder 34, surrounding the central hole or opening 36. For some applications the tray pipe or cylinder 34, surrounding the central hole or opening 36, could be secured along a peripheral edge of the hole or opening 36. For some applications one could also have at least one inner spool side wall 32, secured to the upper or top or first surface 31A. It is preferred that the at least one inner spool side wall 32, is either of a circular or an oval shape. For some applications one could also have a second or outer or peripheral side wall 67, on the upper or top or first surface 31A. For some applications the second or outer peripheral side wall 67, could be secured to the upper or top or first surface 31A, along an outer or peripheral edge 30C, of the at least one base 30. However, it should be appreciated that the second side wall 67, could be secured along any location on the upper or top or first surface 31A. A cable/wire 66, having a first or unsecured end 66A, and a second or secured end 66B, could be placed inside the inventive cable/wire dispenser spool tray apparatus 63, such that the first end 66A, is free to be pulled by an operator or installer (not shown), while the second end 66B, could be removeably, engaged or secured to the inner spool side wall 32. For some applications the second side wall 67, could have at least one hole or opening 35, for the free passage of the open end 66A, of the cable/wire 66.

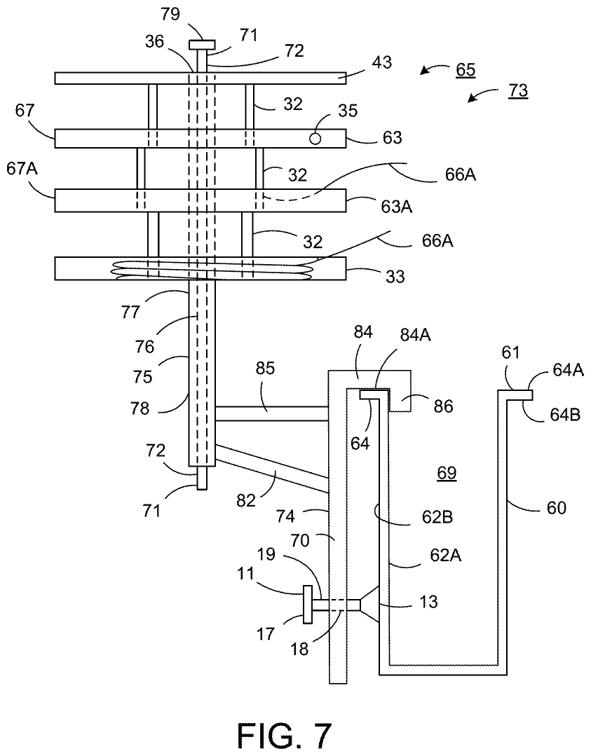

FIG. 7, illustrates a side view of an inventive cable/wire dispenser rack apparatus 23, 53, 75, having a cable/wire dispenser spool tray 33, 63, 63A, and spool tray cover 43, secured to an installation bucket 60, according to a seventh embodiment 73, of this invention. The installation bucket 60, has an inner side wall 62A, an outer side wall 62B, a top peripheral edge 61, having an upper lip or extension 64, and where the upper lip or extension 64, has a first or top surface 64A, and a second or bottom surface 64B. The installation bucket 60, has a cavity or space or blind hole 69, to accommodate at least one operator or installer (not shown). The inventive cable/wire dispenser rack apparatus having a cable/wire dispenser spool tray and spool tray cover secured to an installation bucket 73, comprises of an installation bucket 60, at least one inventive cable/wire dispenser rack apparatus or at least one bucket mounting bracket 75, and at least one inventive cable/wire dispenser spool tray apparatus 65. The cable/wire dispenser spool tray 63A, could be similar to the cable/wire dispenser spool tray 33, 63, but it does not have a hole or opening 35, along a second or outer sidewall 67A. It should be appreciated that the at least one inventive cable/wire dispenser spool tray apparatus 65, is similar to the at least one inventive cable/wire dispenser spool tray apparatus 33, 63, 63A, and it could contain a plurality of the inventive cable/wire dispenser spool tray apparatus 33, 63, 63A. The inventive cable/wire dispenser rack apparatus 75, comprises of at least one center or central shaft 70, having at least one bucket extension 84, on one side and at least one spool tray brace arm or spool extension 85, on an opposite side. The at least one bucket extension 84, has a bottom or lower surface 84A, and has at least one lip or extension 86, at an end away from the at least one center shaft 70, and away from the at least one spool tray brace arm 85. One end of the at least one spool tray brace arm 85, would be secured to an outer surface 74, of the at least one center shaft 70, and the opposite end would be secured to an outer surface 78, of at least one cable/wire post holder 77. For some applications one could also have at least one brace or support arm 82, which physically and securely connects the outer surface 74, of the at least one center shaft 70, to the outer surface 78, of the at least one cable/wire post holder 77. For some applications the at least one post holder 77, could have at least one hole or opening 76, along the center or vertical axis. The inventive cable/wire dispenser rack apparatus 75, should also have at least one securing means 17. The at least one securing means 17, are preferably along the bottom half of the center shaft 70, and are along a horizontal axis. The at least one securing means 17, comprises of a shaft 19, having a knob or handle 11, at one end and a securing pad or bumper 13, at an opposite end. The shaft 19, is passed through an opening or hole 18, in the central shaft 70, such that the knob 11, is on the side of the post holder 77, and that the securing pad 13, is on the side of the bucket extension 84, or lip 86. For some applications the outer surface of the shaft 19, could have screw threads so as to allow the shaft 19, to move back and forth as a screw when the knob or handle 11, is rotated in a clockwise or counterclockwise direction. An operator or installer (not shown) typically will take the bucket extension 14, 54, 84, of the inventive cable/wire dispenser rack apparatus 23, 53, 75, and install it along a top peripheral edge 61, of the installation bucket or basket 60, such that the lip or extension 16, 86, are along the inside wall 62A, of the installation bucket 60. The installation bucket 60, is a typical installation bucket 60, that is well known to a person skilled in the art. The installation bucket 60, has a cavity 69, which is big enough to accommodate at least one operator or cable/wire installer (not shown). The installation bucket 60, typically has a lip or extension 64, along the peripheral edges 61. During installation of the inventive cable/wire dispenser rack apparatus 23, 53, 75, onto the installation bucket 60, the operator should place the bucket extension 14, 54, 84, over the lip or extension 64, such that the lip 16, 86, is on the inside portion of the installation bucket 60, and in the area of the cavity 69, and that the lower or bottom surface 84A, sits on top of the top or upper surface 64A, of the lip or extension 64. The next step for the operator or cable/wire installer would be to tighten the securing means 17, by rotating the knob or handle 11, either clockwise or counterclockwise so that the pad 13, moves towards an outer wall surface 62B, of the installation bucket 60, and is in secure contact with the outer wall surface 62B, so that the inventive cable/wire dispenser rack apparatus 23, 53, 75, does not move once removeably engaged and secured to the installation bucket 60. The inventive cable/wire dispenser spool tray post apparatus 65, could also comprise of a center shaft or mounting post 71, having an outside post surface 72, and at least one post stop 24, as shown in FIG. 2, or securing means, 52A, such as, a set of threads 52A, as discussed with reference to FIG. 5. The next step would be for the installer to install the inventive cable/wire dispenser spool tray post apparatus 20, 20A, into the hole or opening 76, of the cable/wire post holder 77. For some applications the inventive cable/wire dispenser spool tray post apparatus 20, 20A, would be held in place using the post stop 24, while for some other applications other means could be used, such as, the inventive cable/wire dispenser spool tray post apparatus 20, 20A, having threads along the outer surface 22, 52, 72, which could mate with inner threads installed inside the spool post holder 27, 57, 77, along the opening or hole 26, 56, 76. The next step would be for the installer to install at least one inventive cable/wire dispenser spool tray apparatus 33, 63, 63A, using the hole or opening 36, and using the center shaft or mounting post apparatus 21, 51, 71, as a guide. For some applications, the installer could also install the inventive cable/wire dispenser spool tray cover apparatus 43, after the installation of one or more inventive cable/wire dispenser spool tray apparatus 33, 63, 63A. Please note that these installation steps are mentioned for illustration purposes only, and one could use different steps to install the inventive assembly 23, 20, 33, 43, 53, 63, 63A, 73, etc. For most applications it is preferred that the cable/wire 66, is installed into the inventive cable/wire dispenser spool tray apparatus 33, 63, 63A, before the inventive cable/wire dispenser spool tray apparatus 33, 63, 63A, is installed onto the inventive cable/wire dispenser spool tray post apparatus 20, 20A. For some applications the mounting post 21, 51, 71, could be provided with at least one securing means 79, where the at least one securing means 79, could securely hold the cover 43, and the cable/wire tray 33, 63, 63A, in one place and to prevent the sliding out of the cover 43, and the cable/wire tray 33, 63, 63A, from the post 21, 51, 71.

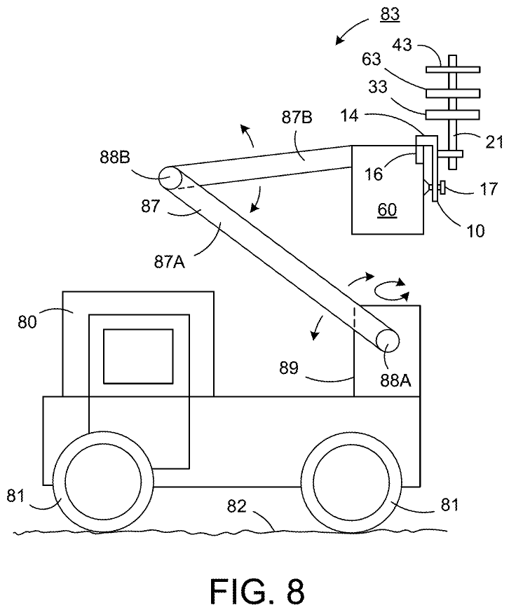

FIG. 8, illustrates a side view of an inventive cable/wire dispenser rack apparatus 23, 53, 75, having a cable/wire dispenser spool tray 33, 63, 63A, and spool tray cover 43, secured to an installation bucket 60, on a cable/wire installation vehicle 80, according to an eight embodiment 83, of this invention. The cable/wire installation vehicle 80, typically has at least two wheels 81, so that the cable/wire installation vehicle 80, is mobile or can move around on a surface 82, and the cable/wire installation vehicle 80, has at least one set of booms or arms 87, such that one end of the boom 87, is secured to a housing 89, of the cable/wire installation vehicle 80, while the other end is secured to the installation basket or bucket 60. For some applications the boom 87, could have one or more boom arms, such as, boom arm 87A, 87B, which could pivot or rotate about a hinge 88A, 88B. The cable/wire installation vehicle 80, could also have a housing 89, which could rotate or move about 360 degrees, to allow the operator or installer to accurately position the at least one installation bucket 60, at or close to the cable/wire installation site. For some applications the cable/wire installation vehicle 80, could be selected from a group comprising a bucket truck 80, a bucket buggy 80, an aerial installation vehicle 80, to name a few.

It should be appreciated that the attached drawings illustrate a new cable/wire deployment system for when the cable/wire 66, needs to be installed. The cable/wire 66, are normally delivered in large industrial spools (not shown) which an operator or installer cannot lift or move it to a site without the use of specialize industrial vehicles. In the past, for example, for a cable/wire installation job the operator would usually have to pull the loose cable/wire 66, from the industrial spool which has the cable/wire 66, coiled around it. The operator would then lay the loose cable/wire 66, pulled from the industrial spool onto the ground, and then rewind the loose cable/wire 66, onto a smaller spool, or just take what the installer needed for the job, which is clearly a very labor-intensive job. However, this inventive system allows the operator or installer to pull out the cable/wire 66, from the installation basket 60, of a bucket truck 80, so that the operator does not have to unwind the cable/wire roll by hand on the ground. This inventive system allows for multiple cable/wire dispenser spool tray apparatus 33, 63, 63A, etc., and having different, or same cables/wires 66, to be pulled at one time. Depending on how many cables/wires 66, the installer or operator needs pulling or installing determines how many cable/wire trays 33, 63, 63A, one needs to stack on the mounting post 21, 51, 71.

For a typical cable/wire installation the first step for the operator or installer would be to mount the inventive cable/wire dispenser rack apparatus 23, 53, 75, onto the installation bucket 60, and then insert the mounting post 21, 51, 71, into the post holder 27, 57, 77. If pulling or installing one (1) cable/wire 66, then the installer only needs to install one tray 33, 63, 63A, onto the mounting post 21, 51, 71, which could then be followed by the installation of the cover or lid 43, to keep the cable/wire 66, inside the tray 33, 63, 63A. If a second cable/wire 66, is required then the operator simply removes the cover or lid 43, and adds or insert the second tray 33, 63, 63A, onto the mounting post 21, 51, 71. Similarly, if a third (3) cable/wire 66, is required then the operator would again simply remove the cover or lid 43, and install or add the third tray 33, 63, 63A, and then add the cover or lid 43, back. It should be appreciated that each tray 33, 63, 63A, will spin independently of each other as the operator or installer moves down the line installing or pulling the cable/wire 66.

As shown in FIG. 2, the inventive cable/wire dispenser spool tray post apparatus 20, comprises of a center shaft or mounting post 21, having an outside post surface 22, and at least one post stop 24. However, for some applications the center shaft or mounting post 21, could have, for example, a plurality of post stops 24, where the bottom surface 24B, of the first post stop 24, would sit on the top surface 27A, of the post holder 27, while the lower surface 31B, of the inventive cable/wire dispenser spool tray apparatus 33, 63, 63A, would sit on the top or upper surface 24A, of the post stop 24, and then the next post stop 24, would be between the next inventive cable/wire dispenser spool tray apparatus 33, 63, 63A, as shown in FIG. 7, such that one or more of the at least one post stop 24, acts as a spacer 24, between the various stacking components. For some applications the at least one post stop 24, could be welded or permanently secured to the outer surface 22, of the center shaft or mounting post 21, while for some other applications the at least one post stop 24, could be slidably, secured and engaged with the outer surface 22, of the center shaft or mounting post 21.

The inventive cable/wire dispenser spool tray apparatus 33, 63, 63A, and/or the inventive cable/wire dispenser spool tray cover apparatus 43, could be made of a material selected from a group comprising of plastic, rubber, metal, iron, copper, aluminum, brass, stainless steel, composite material, and combinations thereof.

The installation bucket 60, is made of an electrically nonconductive material. However, for some applications the installation bucket 60, could be made of a material selected from a group comprising plastic, rubber, metal, iron, copper, aluminum, brass, stainless steel, composite material, and combinations thereof.

The cable/wire 66, could be selected from a group comprising of an electrical wire, a copper wire, a telephone cable, a fiberoptic cable, a television cable, and combinations thereof.

As one can clearly see, such as, in FIG. 7, FIG. 8, that the inventive cable/wire dispenser spool tray apparatus 23, 53, 65, etc., once removeably, and securely installed to the installation bucket 60, is on the outside of the installation bucket 60, and thus leaving room for the cable/wire installer to freely move about the installation bucket 60, and not be concerned about tripping or getting entangled with loose cable/wire 66, as was done in the past. Additionally, the cable/wire installer now does not have to bend down to pick-up the cable/wire 66, during installation, as the cable/wire 66, is now at a higher level, and within his arms reach. It should be noted that constant bending in a small, confined area, such as, within the cavity or inner space 69, of the installation bucket 60, can be stressful on the backs of the cable/wire installers, and this invention removes that stress. Furthermore, this inventive cable/wire dispenser spool tray apparatus 23, 53, 65, etc., has all the necessary securing features that it can be very easily and securely installed with any installation bucket 60, and then can be very easily removed without leaving any installation footprint. Additionally, this inventive cable/wire dispenser spool tray apparatus 23, 53, 65, etc., does not need any special tools of fixtures to secure it to an installation bucket 60, as it comes with all the necessary items to securely, and removeably install it to an installation bucket 60. It should further be appreciated that this inventive cable/wire dispenser spool tray apparatus 23, 53, 65, etc., is universal in nature, and can be used or securely installed with any type of cable/wire installation bucket 60.

Thus, the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Still further, while certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

It should be further understood that throughout the specification and claims several terms have been used and they take the meanings explicitly associated herein, unless the context clearly dictates otherwise. For example, the phrase “in one embodiment” as used herein does not necessarily refer to the same embodiment, though it may. Additionally, the phrase “in another embodiment” as used herein does not necessarily refer to a different embodiment, although it may. Thus, various embodiments of the invention may be readily combined, without departing from the scope or spirit of the invention.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A cable/wire installation apparatus, comprising:
(a) a center shaft having a bucket extension at one end, and a spool extension at an opposite end, said bucket extension having a lip extension at a free end, and wherein said lip extension points towards earth, said spool extension has a post holder at a free end, and wherein said post holder has a central through hole;
(b) a mounting post having a post stop, said post stop having an upper surface, and a lower surface, and wherein one end of said post stop is inserted into said central through hole, while said lower surface of said post stop rests on a surface of said post holder; and
(c) a cable/wire tray having a through hole is inserted onto said mounting post, such that a base of said cable/wire tray rests on an upper surface of said post stop.

2. The apparatus of claim 1, wherein said cable/wire tray is made of a material selected from a group consisting of plastic, rubber, metal, iron, copper, aluminum, brass, stainless steel, composite material, and combinations thereof.

3. The apparatus of claim 1, wherein said mounting post is made of a material selected from a group consisting of plastic, rubber, metal, iron, copper, aluminum, brass, stainless steel, composite material, and combinations thereof.

4. The apparatus of claim 1, wherein a tray cover having a central opening is inserted into top of said mounting post such that a portion of said tray cover substantially covers said cable/wire tray.

5. The apparatus of claim 4, wherein material for said tray cover is selected from a group consisting of plastic, rubber, metal, iron, copper, aluminum, brass, stainless steel, composite material, and combinations thereof.

6. The apparatus of claim 1, wherein said cable/wire tray has a spool of cable/wire, and wherein one end of said spool of cable/wire is engageably secured to said cable/wire tray, while an opposite end of said spool of cable/wire is free.

7. The apparatus of claim 1, wherein said cable/wire tray has at least one inner sidewall.

8. The apparatus of claim 1, wherein said cable/wire tray has at least one outer sidewall.

9. The apparatus of claim 1, wherein said cable/wire tray has at least one outer sidewall, and wherein said outer sidewall has at least one opening for a passage of at least one cable/wire.

10. The apparatus of claim 1, wherein said mounting post has at least one securing means at one end to securely hold one of said cover and said cable/wire tray.

11. The apparatus of claim 1, wherein at least one support bracket securely supports said spool extension.

12. A cable/wire installation apparatus, comprising:
(a) a center shaft having a bucket extension at one end, and a spool extension at an opposite end, said bucket extension having a lip extension at a free end, and wherein said lip extension points towards earth, said spool extension has a post holder at a free end, and wherein said post holder has a central through hole;
(b) a post having a post stop, said post stop having an upper surface, and a lower surface, and wherein one end of said post stop is inserted into said central through hole, while said lower surface of said post stop rests on a surface of said post holder;
(c) a cable/wire tray having a through hole is inserted onto said post, such that a base of said cable/wire tray rests on an upper surface of said post stop; and
(d) an installation bucket having a base, a sidewall having a bottom end and a top end, and where a portion of said bottom end is connected to said base, and at least one lip extension is connected along at least a portion of said top end, and wherein bucket extension rests on top of said at least one lip extension, such that said lip extension of said bucket extension is inside said installation bucket.

13. The apparatus of claim 12, wherein said installation bucket is made of an electrically nonconductive material.

14. The apparatus of claim 12, wherein said installation bucket is made of a material selected from a group consisting of plastic, rubber, metal, iron, copper, aluminum, brass, stainless steel, composite material, and combinations thereof.

15. The apparatus of claim 12, wherein said center shaft has at least one securing means, and wherein said securing means has a first end and a second end, and wherein said first end has at least one handle, and said second end has at least one bumper, and wherein said bumper is in secure contact with a surface of said sidewall of said installation bucket.

16. The apparatus of claim 12, wherein said cable/wire tray has at least one cable/wire, and wherein said cable/wire is selected from a group consisting of an electrical wire, a copper wire, a telephone cable, a fiberoptic cable, a television cable, and combinations thereof.

17. A cable/wire installation apparatus, comprising:
(a) a center shaft having a bucket extension at one end, and a spool extension at an opposite end, said bucket extension having a lip extension at a free end, and wherein said lip extension points towards earth, said spool extension has a post holder at a free end, and wherein said post holder has a central through hole;
(b) a post having a post stop, said post stop having an upper surface, and a lower surface, and wherein one end of said post stop is inserted into said central through hole, while said lower surface of said post stop rests on a surface of said post holder;
(c) a cable/wire tray having a through hole is inserted onto said post, such that a base of said cable/wire tray rests on an upper surface of said post stop;
(d) an installation bucket having a base, a sidewall having a bottom end and a top end, and where a portion of said bottom end is connected to said base, and at least one lip extension is connected along at least a portion of said top end, and wherein bucket extension rests on top of said at least one lip extension, such that said lip extension of said bucket extension is inside said installation bucket; and
(e) an installation vehicle, said installation vehicle having a housing having at least one extension, wherein one end of said at least one extension is moveable secured to said housing, and an opposite end is secured to said installation bucket.

18. The apparatus of claim 17, wherein said installation vehicle has at least two wheels.

19. The apparatus of claim 17, wherein said housing is secured to said installation vehicle, and wherein said housing is rotatable along a vertical axis.

20. The apparatus of claim 17, wherein said at least one extension secured to said housing is moveable along an up and down motion.
